(19) United States
(12) Patent Application Publication
(10) Pub. No.: US 2023/0417356 A1
(43) Pub. Date: Dec. 28, 2023

(54) BOLTED AND WELDED CLAMP-TYPE REPAIR WITH RECESSED BOLTS

(71) Applicants: PETRÓLEO BRASILEIRO S.A. - PETROBRAS, Rio de Janeiro (BR); UNIVERSIDADE FEDERAL DE SANTA CATARINA - UFSC, Florianópolis (BR)

(72) Inventors: GIOVANI DALPIAZ, Rio de Janeiro (BR); LAERCIO MENESES SILVA, JR., Florianópolis (BR); PAULO DE TARSO ROCHA DE MENDONÇA, Florianópolis (BR); RÉGIS HENRIQUE GONÇALVES E SILVA, Florianópolis (BR); MATEUS BARANCELLI SCHWEDERSKY, Florianópolis (BR); RAFAEL ALBINO BERNARDI, Florianópolis (BR); JOSÉ CARLOS DE CARVALHO PEREIRA, Florianópolis (BR); FRANCISCO FRANCELINO RAMOS NETO, Rio de Janeiro (BR); MARCELO TORRES PIZA PAES, Rio de Janeiro (BR); MAXMILIAN MAINARDI, Guarulhos (BR); EDUARDO ALBERTO FANCELLO, Florianópolis (BR); FABIO DE CASTRO MARANGONE, Rio de Janeiro (BR); RICARDO REPPOLD MARINHO, Rio de Janeiro (BR)

(21) Appl. No.: 18/341,297

(22) Filed: Jun. 26, 2023

(30) Foreign Application Priority Data
Jun. 27, 2022 (BR) 20 2022 012828 1

(51) Int. Cl. F16L 55/172

(52) U.S. Cl. CPC F16L 55/172

(57) ABSTRACT

The present model refers to a bolted and welded clamp-type repair with bolts and nuts housed in recessed locations that will be hermetically insulated by welding plugging discs to be used in the repair and maintenance of pipes. The clamp-type repair comprises a lower part (1) and an upper part (2) that will perfectly accommodate the pipe, wherein said lower part (1) and upper part (2) each comprise a flanged portion (3) at both ends, and the flanged portions (3) each comprise at least one recess (4) to accommodate the bolt-nut assembly (7) where the plugging discs (8) will be positioned immediately above. The welding process of the edges between the same and next to the pipe (12) and the plugging discs (8) next to the surface of the flanges (3) guarantee the necessary safety and enable the repair to be defined as permanent, without the need for later replacement.

### TECHNICAL FIELD

The present model refers to a repair to be used and fixed in pipes present in industries that use in their activities such pipes to transport substances, such as oil.

Said repair includes new functionalities in its composition and forms of application, which ensures that, after its installation, it is considered permanent in the place used, without the need for future alteration as if it was a commonplace repair of the state of the art, which would be provisional.

### BACKGROUND

Many industries widely use pipelines in their processes, in which these structures comprise large pipes and their interconnections where various types of substances are included, such as: petroleum, chemicals, water, oil, gas and others.

However, the used pipes, despite being produced in resistant materials, are subject to defects of the most varied types, whether they are design, manufacturing, installation errors, third-party action, natural wear or the action of corrosive products. All of these situations can compromise the integrity of the pipes, which must be carefully and periodically inspected in order to identify and mitigate possible problems before a major collapse occurs, such as a leak.

When identifying potential failures, several types of interventions can be carried out, but side effects are inevitable since the need for operational interruption, the risk of accidents, excessive time for repair preparation and other problems are linked to the repair of problems of this nature.

In this way, several types of repairs were created to try to solve possible found problems and minimize the aforementioned damage, including repairs in the form of a clamp that directly insulate the damaged area. As an example of repairs adopted in the market we have: bolted clamps, plug, patches, overlay and others.

Bolted clamp-type repairs are considered an agile execution method; however, they have features that may cause problems in the future, which often characterizes the same as a temporary repair, requiring the planning of future interventions.

### STATE OF THE ART

U.S. Pat. No. 4,652,023 “Repair coupler” discloses a clamp for repairing leaks in pipes. The repair clamp is said to have two identical portions that have a complementary relation. Each of the two members of the clamp is formed to include a semi-circular cross-sectional portion and outwardly extending longitudinal flanges on each side of the semi-circular portion.

Furthermore, each semi-circular portion includes a plurality of spaced apart grooves for receiving semi-circular structural elements (ribs) of a liner. Furthermore, each member of the clamp has a longitudinal recess adjacent each side of the semi-circular portion for receiving a longitudinal section of a sealing liner. Said sealing liner includes a plurality of spaced apart structural elements (ribs) fitted into grooves and longitudinally extensible connecting sections received in longitudinal recesses.

It is also disclosed that the ribs fit the pipe and the longitudinal sections fit together to form a seal. The clamp members are held together by simple fasteners such as machine screws received in flange holes and hex nuts received in flange recesses. The holes in the coupler flanges contain restricted portions to retain the machine screws and the recesses in the flanges are molded to retain the nuts.

Document U.S. Pat. No. 5,950,683 “Pipe repair assembly” discloses a pipeline repair clamp for sealing leaks in a pipeline.

The clamp is said to comprise a pair of half-sleeves, each with a pair of mounting flanges along their side edges that are adapted to align with similar flanges on the other half-sleeve of the clamp. Further, the half-sleeves are of sufficient length to enclose a leak area in a pipeline, and a jacket of sealing material is pre-fitted to the half-sleeves to provide a snug-fit over the surface of the pipeline when the half-sleeves are positioned thereon. Each half-sleeve has one half of an outer circumferential compression ring of steel secured to the inner surface of the half-sleeve adjacent the ends thereof, and securing means are provided to secure the flanges of the sleeves to form the complete clamp assembly.

In addition, it is further disclosed that the mounting flanges are welded along the edges of each half-sleeve and are drilled to accommodate the studs or screws needed to secure the two half-sleeves together in the mounting position.

Document DE19519341 “Repair kit for mending pipeline” discloses a sealing clamp that is divided into two identical halves around a horizontal plane, and each half has side flanges that are fastened together to complete the clamp. Sealing rings on the center section of each half of the clamp are positioned on either side of the break in the pipe to contain the fluid in the pipe, while the end sections of the clamps have integral electrical heating coils to weld them to the pipe. To fit the repair clamp, one half of the clamp is positioned over the top of the break and is rotated under the pipe once the fluid has drained. The second half of the clamp is then placed on top and the sealing process is activated.

The model proposed in the present patent application proposes, in a way distinct from the state of the art, a clamp for permanent repair in pipes, wherein said clamp is bolted and welded, hermetically sealing the place where its bolts and nuts are housed.

The proposed clamp has recesses in the flange to accommodate the bolts and nuts. It is seen that the clamp must be mounted on the pipe at the damage site, with subsequent tightening of the bolts, cutting of the ends of the bolts to the flange recess, welding of the plates that seal the recesses and welding of all longitudinal and circumferential joints of the clamp.

It is public knowledge that it is not feasible to weld nuts and bolts, since the used material is not designed to be welded.

In this way, the creation of plugging discs was a solution to function as a cover, in order to protect these non-weldable parts in a hermetic place. This feature enabled the repair to be considered permanent, since if the internal sealing polymeric element fails due to the action of time or the action of agents, there is still a sealing barrier (weld) to guarantee the sealing and, consequently, possible leaks.

Therefore, the recesses and plugging discs of the bolts and nuts were proposed, in order to allow an integral sealing of the clamp, without having to weld the bolts and nuts, since they are hermetically accommodated in the created internal space.

Such a difference leads to significant improvements as it initially avoids a later intervention to make repair exchange alterations or restorations in the damaged section. Thus, replacing a repair that is temporary (not sealed) leads to the interruption of the use of the pipe and consequently generates problems for the productivity of the proprietary industry.

Brief Description of the Model:

The present model refers to a bolted and welded clamp-type repair with bolts and nuts housed in recessed locations that will be hermetically insulated by welding plugging discs to be used in the repair and maintenance of pipes used preferably in petrochemical industries.

The present model has recesses in the flange to accommodate the bolts and nuts, which will ensure the aforementioned hermetic insulation. Therefore, after the correct fixation, the plugging discs are positioned and welded to the structure to guarantee its insulation.

This type of repair must be positioned and fixed on the pipe in the damaged location, perform the entire sealing process via welding on all longitudinal and circumferential joints of the clamp.

### BRIEF DESCRIPTION OF THE FIGURES

In order to obtain a total and complete visualization of the object of this model, the figures to which references are made are presented, as follows.

FIG. 1 shows the repair containing the chamfers that will later receive welding in addition to the flanges with the container where the nuts and bolts will be allocated.

FIG. 2 shows the repair previously installed in a pipe detailing its welding locations, the nuts and bolts positioned and the plugging discs.

FIG. 3 shows the repair installed in a pipe with details of the plugging discs housed in the places that will be welded.

FIG. 4 shows a real example of the repair being used in a pipe, but before performing the welding process.

FIG. 5 shows a real example of the repair being used in a pipe in its final process, after welding.

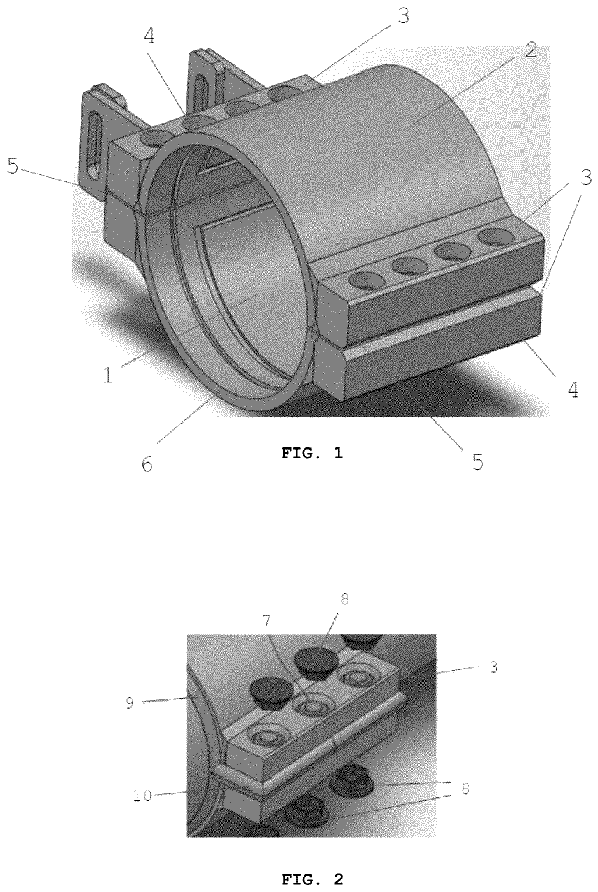

### DETAILED DESCRIPTION OF THE MODEL

The present model presents a repair for metallic pipes (12) of the bolted and welded clamp-type containing bolts and nuts (7) hermetically housed in recesses (4) present in the flanges (3) contained in the lower part (1) and upper part (2) of the repair.

The clamp-type repair comprises a lower part (1) and an upper part (2), preferably in a similar shape to a semicircle, in order to perfectly accommodate the pipe of interest (12), in which said lower part (1) and upper part (2) each comprise a flanged portion (3) at both ends, wherein said flanged portions (3) comprise at least one recess (4) to accommodate the bolt-nut assembly (7) in which they will be hermetically insulated after positioning immediately above the plugging discs (8), which will later be welded next to the surface of the flanges (3).

Thus, the use of the proposed repair begins with the positioning of the lower part (1) and upper part (2) in the pipe of interest (12) at the damage site. Subsequently, the tightening of the assembly of bolts and nuts (7) is carried out so that both the nuts and the bolts must be completely accommodated/housed inside the recesses (4) contained at the ends of the portion of the flanges (3).

After the correct positioning and fixation of the aforementioned parts, the circumferential edges (6) immediately in contact with the pipe of interest (12), are formed by the union of the lower part (1) and upper part (2), and the longitudinal edges (5) are formed by joining the flanged portions (3) of the lower part (1) and upper part (2), wherein the circumferential edges (6) and longitudinal edges (5) are welded between the same and next to the pipe (12).

The plugging disks (8) are positioned in the recesses (4) in order to cover/seal the hole where the bolt-nut assemblies are located.

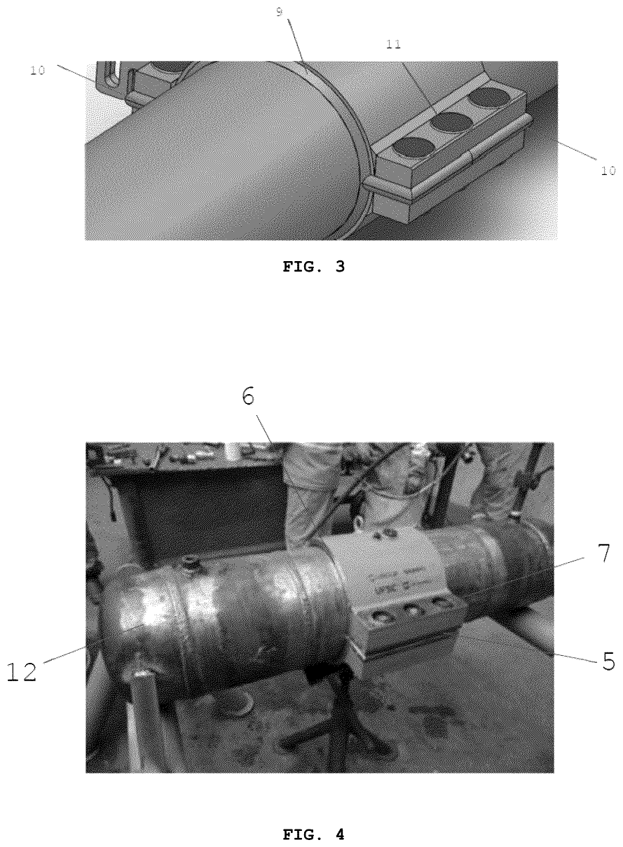

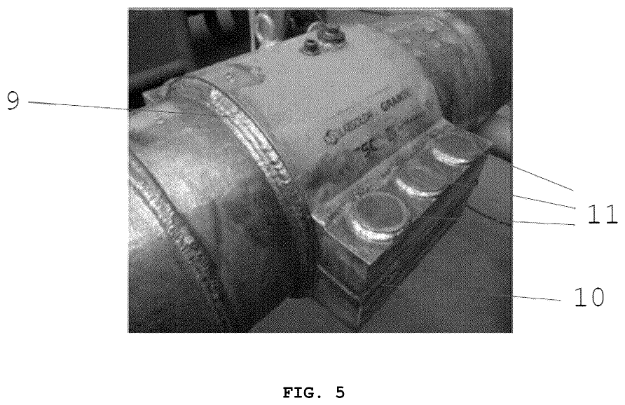

Finally, the longitudinal edges (5), the circumferential edges (6) and the plugging discs (8) are subjected to the welding process, in order to achieve the proposed complete seal and ensure the permanent character of the repair, wherein the longitudinal edges (5) and circumferential edges (6) are welded together and next to the pipe (12) and the plugging discs (8) are welded next to the surface of the flanges (3). In this way, and as can be seen in FIGS. 3 and 5, the parts necessary for complete sealing are already presented with the welding process completed, namely: the welded circumferential edges (9), the welded longitudinal edges (10) and the welded plugging discs (11), thus guaranteeing the desired complete seal.

It should be emphasized that to enable welding of the circumferential edges (6) and longitudinal edges (5) of the clamp, the repair was preferably produced using a material of high weldability, except for the bolts and nuts that are naturally manufactured in very low weldability material, a feature that motivated the design of this repair. The figures demonstrate that the notches (chamfers) are already machined in the fabrication of the proposed clamp-type repair to allow for welding and ensure a resistant section.

Furthermore, the dimensions of the repair are variable, obeying the diameter of the pipe of interest (12) and the loads that must be submitted to. In addition, the number of recesses (4) contained in the flanges (3) is not fixedly defined, but the flange must have at least one recess (4) for the use of at least one bolt-nut assembly (7) and consequently have the longitudinal edges (5) to be welded between the same and next to the pipe (12).

1. A bolted and welded clamp-type repair with recessed bolts comprising:
a lower part comprising:
a circumferential edge;
a longitudinal edge; and
a flanged portion;
an upper part, comprising:
a circumferential edge;
a longitudinal edge and;
a flanged portion;
wherein the flanged portion of the lower part and the flanged portion of the upper part each comprise at least one recess to accommodate at least one bolt-nut assembly; and one or more plugging disks positioned immediately above the bolt-nut assembly and welded next to the surface of the flange of the upper part and;
wherein the circumferential edges of the lower part and the upper part are welded to a pipe and wherein the and longitudinal edges of the upper and lower flanges are welded together.
